(19) United States
(12) Patent Application Publication
(10) Pub. No.: US 2007/0110026 A1
(43) Pub. Date: May 17, 2007

(54) Systems and methods for dual power and data over a single cable

(75) Inventors: Amit Sinha, Marlborough, MA (US); David N. Gagne, Newburyport, MA (US)

Correspondence Address: FISH & RICHARDSON P.C., P.O BOX 1022, Minneapolis, MN, 55440-1022, US

(73) Assignee: AirDefense, Inc.

(21) Appl. No.: 11/274,376

(22) Filed: Nov. 14, 2005

(51) Int. Cl. H04L 12/28

(52) U.S. Cl. 370/351

(57) ABSTRACT

A system for providing power and data to at least two Ethernet devices over a common Ethernet cable includes a combiner circuit and a splitter circuit. The combiner circuit receives first and second Ethernet cables and is configured to route power and data signals communicated over the first and second Ethernet cables over a common cable. The splitter circuit is configured to receive the common cable and route the power and data signals routed over the common cable over third and fourth Ethernet cables.

This disclosure relates to power and data systems and methods, and more particularly to systems and methods that can simultaneously provide independent power and data to two separate Ethernet devices over a single Ethernet cable.

### BACKGROUND AND SUMMARY

The IEEE standards 802.3-2000 and 802.3af-2003, which are incorporated herein by reference, relate to Ethernet devices and powering remote devices over an Ethernet based network. Devices communicating according to the IEEE 802.3 standard use RJ-45 connectors and four pairs of twisted pair cables. The IEEE 802.3af standard amended the IEEE 802.3 standard to include “Power of Ethernet” (PoE) capability, which is the ability to directly provide power to an end station over two of the twisted pair cables.

Under IEEE 802.3af, two schemes, Scheme A and Scheme B, exist for Power over Ethernet (PoE). In Scheme A, Power Sourcing Equipment (PSE), usually present in a Hub/Switch, supplies power on the same two twisted pairs that are used for transmitting data. The data lines are transformer coupled and the power supply is sourced into the secondary winding of the transformer from the PSE. On a Powered Device (PD) side, the data lines are transformer coupled and power is obtained from the primary coils of the transformer. In Scheme B, the PSE supplies power directly to the PD over unused twisted pairs. The IEEE 802.3af standard mandates that the PD be able to accept power from both schemes.

The PoE standard thus enables remote devices (e.g., VoIP phones or Wireless Access Points) to operate without a separate power source. The elimination of line voltage AC power simplifies equipment installation and fosters safety. Adding additional remote Powered Devices, however, requires additional Ethernet cabling from the Power Sourcing Equipment.

The systems and methods disclosed herein reduce additional cabling requirements. An example system and corresponding method for providing power and data to at least two Ethernet devices over a common Ethernet cable includes a combiner circuit and a splitter circuit. The combiner circuit receives first and second Ethernet cables and is configured to route power and data signals communicated over the first and second Ethernet cables over a common cable. The splitter circuit is configured to receive the common cable and route the power and data signals routed over the common cable over third and fourth Ethernet cables.

### BRIEF DESCRIPTION OF THE DRAWINGS

FIGS. 1A-1D depict schematic diagrams of RJ-45 connectors and cables;

FIGS. 2A and 2B depict high level block diagrams of two schemes for remote powering from an endpoint PSE according to IEEE 802.3af;

FIGS. 3A-3C are schematic diagrams of an example embodiment of a dual power and data system for remote powering from an endpoint PSE;

FIGS. 4A-4C are schematic diagrams of another example embodiment of a dual power and data system for remote powering from an endpoint PSE;

FIG. 5 is a schematic diagram of another example embodiment of a dual power and data system for remote powering from an endpoint PSE; and

FIG. 6 is a flowchart depicting a method for providing data and power over a common cable to two independent devices; and

FIG. 7 is another flowchart depicting a method for providing data and power over a common cable.

### DETAILED DESCRIPTION

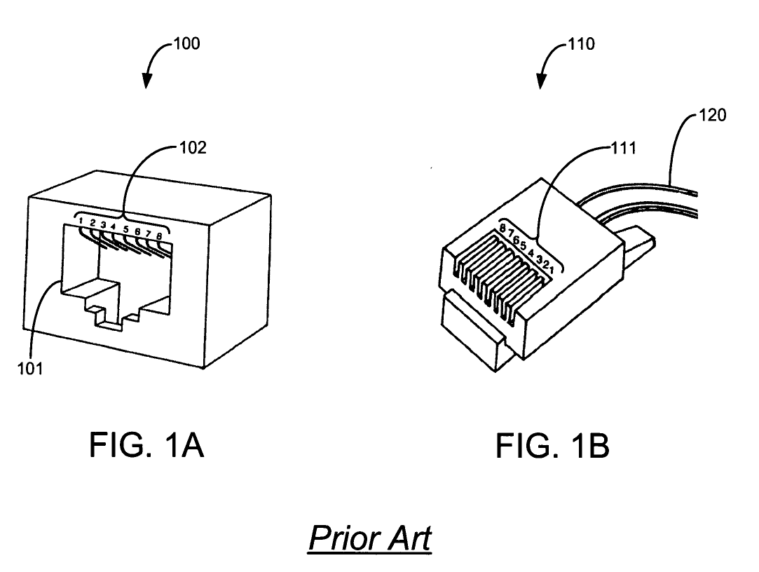

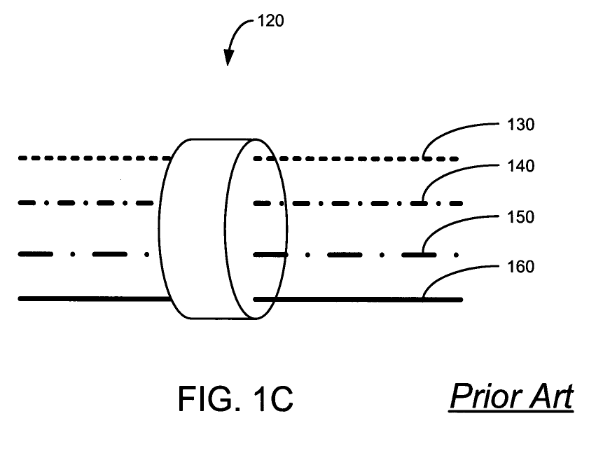

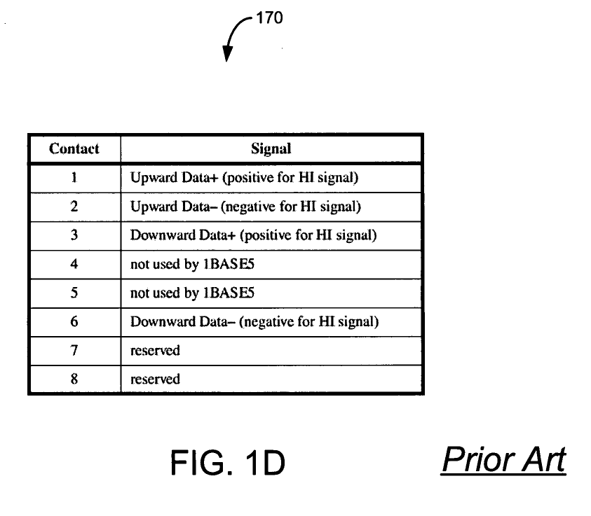

FIGS. 1A-1D depict schematic diagrams of RJ-45 connectors and cables. The RJ-45 connectors have eight pins per connector. FIG. 1A depicts a female RJ-45 connector 100 comprising an input 101 and eight pins 102. The female RJ-45 connector 100 typically is located at a termination point such as, for example, a computer, a switch, a hub, etc. FIG. 1B depicts a male RJ-45 connector 110 having eight pins 111 and attached to an Ethernet cable 120. The male RJ-45 connector 110 typically is connected to the Ethernet cable 120 and is used to connect termination points. FIG. 1C depicts a cross-sectional view of the Ethernet cable 120. The Ethernet cable 120 comprises a first twisted pair connection 130, a second twisted pair connection 140, a third twisted pair connection 150, and a fourth twisted pair connection 160. FIG. 1D depicts a table listing the pin connections of the RJ-45 connectors 100, 110. Pins 1 and 2 connect to the first twisted pair connection 130, and pins 3 and 6 connect to the fourth twisted pair connection 160. The remaining four pins (4, 5, 7, and 8) of the RJ-45 connector, which comprise the second twisted pair connection 140 and the third twisted pair connection 150, are not used in the original IEEE 802.3 standard.

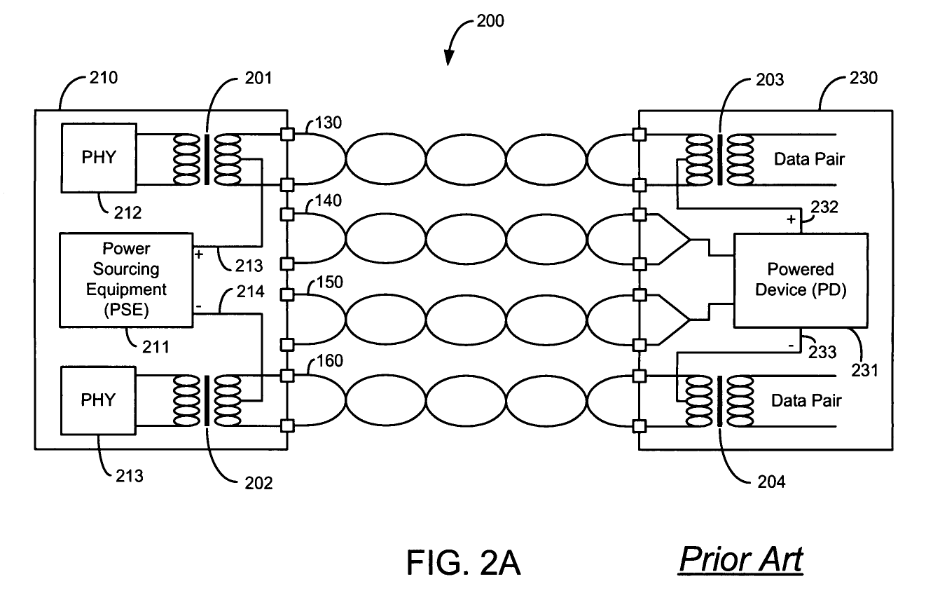

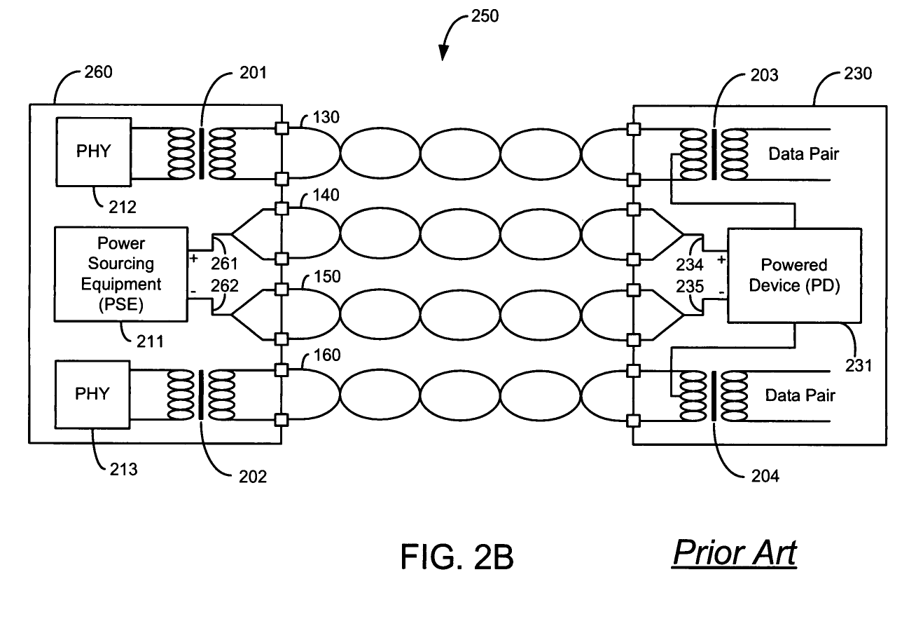

The IEEE 802.3af standard amended the IEEE 802.3 standard to include the PoE capability to directly provide power over two of the twisted pair cables to an end station. The two PoE schemes—Scheme A and Scheme B—are shown in FIGS. 2A and 2B, respectively. The IEEE 802.3af standard mandates that the Powered Device be able to accept power from the Power Sourcing Equipment under both schemes.

FIG. 2A depicts a high level block diagram of a system 200 utilizing Scheme A. In Scheme A, the Power Sourcing Equipment supplies power on the same two twisted pairs that are used for data (pairs 130 and 160).

The system 200 comprises a switch/hub 210, a first twisted pair connection 130, a second twisted pair connection 140, a third twisted pair connection 150, a fourth twisted pair connection 160, and a powered end station 230.

The switch/hub 210 comprises power sourcing equipment (PSE) 211 having a positive power output lead 213 and a negative power output lead 214; a first physical layer (PHY) controller 212; a PHY controller 213; a first transformer 201; and a second transformer 202. The positive output lead 213 is connected to the center tap of the secondary of the first transformer 201, and the negative output lead 214 is connected to the center tap of the secondary of the second transformer 202. The primary of the first transformer 201 is connected to the first physical layer controller 212, and the primary of the second transformer 202 is connected to the second physical layer controller 213. The output leads of the secondary of the first transformer 201 are connected to the first twisted pair connection 130, and the output leads of the second transformer 202 are connected to the fourth twisted pair connection 160.

The powered end station 230 comprises a powered device 231 having a positive power input lead 232 and a negative power input lead 233; a third transformer 203; and a fourth transformer 204. The second end of the first twisted pair connection 130 is connected to the primary of the third transformer 203, and the second end of the fourth twisted pair connection 160 is connected to the primary of the fourth transformer 204. The center tap of the primary of the third transformer 203 is connected to the positive input lead 232, which, in turn, is connected to the powered device 231. The center tap of the primary of the fourth transformer 204 is connected to the negative input lead 233, which, in turn, is connected to the powered device 231.

In operation, the power sourcing equipment 211 supplies both power and data over the first twisted pair connection 130 and the fourth twisted pair connection 160. At the switch/hub 210, the transformers 201 and 202 couple the data in the form of an AC waveform on the primary with DC power from the PSE 211 on the secondary. At the powered end station 230, the transformers 203 and 204 decouple the data in the form of an AC waveform on the secondary and the DC power on the primary. The positive power input lead 232 of the PD 231 is operatively connected to the positive power output lead 213 of the PSE 211 through the first twisted pair connection 130, the center tapped primary of the third transformer 203, and the center tapped secondary of the first transformer 201. The negative power input lead 233 of powered device 231 is operatively connected to the negative power output lead 214 of the PSE 211 through the fourth twisted pair connection 160, the center tapped primary of the fourth transformer 204, and the center tapped secondary of the second transformer 202.

FIG. 2B depicts a high level block diagram 250 of a system utilizing Scheme B. In Scheme B, the PSE 211 supplies power to the PD 231 over the unused twisted pairs (pairs 140 and 150).

The system 250 comprises a switch/hub 260, a first twisted pair connection 130, a second twisted pair connection 140, a third twisted pair connection 150, a fourth twisted pair connection 160, and a powered end station 230. The switch/hub 250 comprises a PSE 211 having a positive power output lead 261 and a negative power output lead 262; a first PHY controller 212; a second PHY controller 213; a first transformer 201; and a second transformer 202. The positive output lead 261 is connected to the second twisted pair connection 140, and the negative output lead 262 is connected to the third twisted pair connection 150. The primary of the first transformer 201 is connected to the first PHY controller 212, and the primary of the second transformer 202 is connected to the second PHY controller 213. The output leads of the secondary of the first transformer 201 are connected to the first twisted pair connection 130, and the output leads of the second transformer 202 are connected to the fourth twisted pair connection 160.

The powered end station 230 comprises a PD 231 having a positive power input lead 234 and a negative power input lead 235; a third transformer 203; and a fourth transformer 204. The second end of the first twisted pair connection 130 is connected to the primary of the third transformer 203, and the second end of the fourth twisted pair connection 160 is connected to the primary of the fourth transformer 204. The third transformer 203 and the fourth transformer 204 are located in the powered end station 230. The second end of the second twisted pair connection 140 within the powered end station 230 is connected to the positive input lead 234. The second end of the third twisted pair connection 150 within the powered end station 230 is connected to the negative input lead 235. The center taps of the primary of the third transformer 203 and the fourth transformer 204 are connected to the powered device 231.

In operation, the power sourcing equipment 211 supplies data over the first twisted pair connection 130 and the fourth twisted pair connection 160, and supplies power over the second twisted pair connection 140 and the third twisted pair connection 150. The positive power input lead 234 of powered device 231 is operatively connected to the positive power output lead 261 of the PSE 211 through the second twisted pair connection 140. The negative power input lead 235 of powered device 231 is operatively connected to the negative power output lead 262 of the PSE 211 through the third twisted pair connection 150, the center tapped primary of the fourth transformer 204, and the center tapped secondary of the second transformer 202.

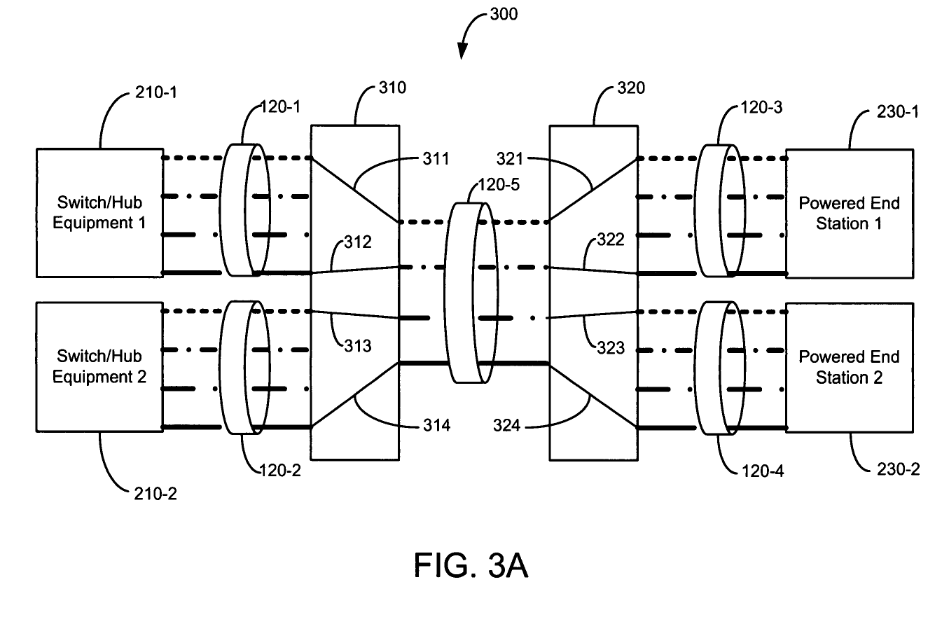

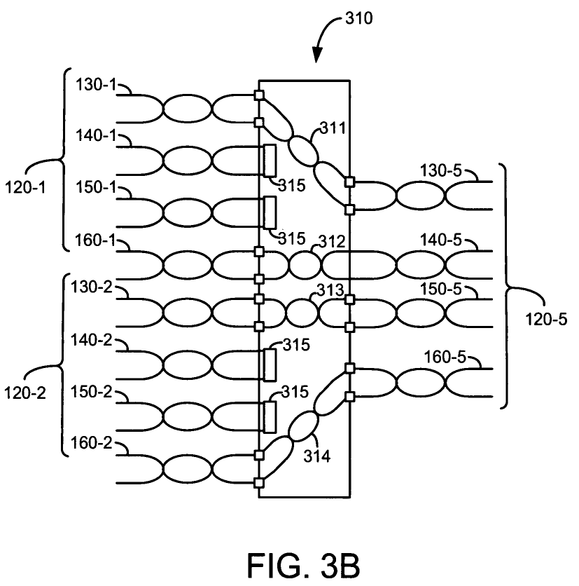

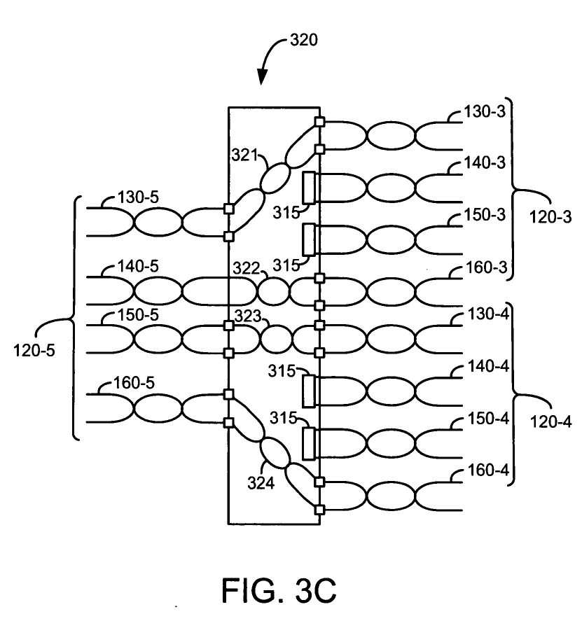

FIGS. 3A-3C are schematic diagrams of an example embodiment of a dual power and data system for remote powering from an endpoint PSE in accordance with Scheme A. The dual power and data system 300 comprises switch/hub equipment 210-1, 210-2; cables 120-1, 120-2, 120-3, 120-4; a common cable 120-5; a combiner 310; a splitter 320; and powered end stations 230-1 and 230-2. The cables 120-1, 120-2, 120-3, 120-4 and the common cable 120-5 each comprise four twisted pair connections, such as an Ethernet or Cat 5 cable. The switch/hub equipment 210-1 and 210-2 are configured to provide power and data according to Scheme A 200 for remote powering.

The dual power and data system 300 combines two cables 120 onto one single common cable 120-5 by wiring the twisted pairs to utilize the unused twisted pair connections in the common cable 120-5. The powered end station 230-1 is operatively connected to the switch/hub equipment 210-1 through the cable 120-3, the splitter 320, the common cable 120-5, the combiner 310, and the cable 120-1. The powered end station 230-2 is operatively connected to the switch/hub equipment 210-2 through the cable 120-4, the splitter 320, the common cable 120-5, the combiner 310, and the cable 120-2. The common cable 120-5 may comprise existing Ethernet cabling.

The combiner 310 is configured to route the signals for cables 120-1 and 120-2 over a common cable 120-5 by utilizing all four twisted pair connections in the common cable 120-5. The combiner 310 comprises a twisted pair 311 connected to a first twisted pair on the switch/hub equipment 210-1 by the cable 120-1 and to a first twisted pair in the common cable 120-5; a twisted pair 312 connected to a fourth twisted pair on the switch/hub equipment 210-1 by the cable 120-1 and to a second twisted pair in the common cable 120-5; a twisted pair 313 connected to a first twisted pair on the switch/hub equipment 210-2 by the cable 120-2 and to a third twisted pair in the common cable 120-5; and a twisted pair 314 connected to a fourth twisted pair on the switch/hub equipment 210-2 by the cable 120-2 and to a fourth twisted pair in the common cable 120-5.

The splitter 320 is configured to route the signals received from the common cable 120-5 over cables 120-3 and 120-4. The splitter 320 comprises a twisted pair 321 connected to the first twisted pair in the common cable 120-5 and to a first twisted pair on the powered end station 230-1 by the cable 120-3; a twisted pair 322 connected to the second twisted pair in the common cable 120-5 and to a fourth twisted pair on the powered end station 230-1 by the cable 120-3; a twisted pair 323 connected to the third twisted pair in the common cable 120-5 and to a first twisted pair on the powered end station 230-2 by the cable 120-4; and a twisted pair 324 connected to the fourth twisted pair in the common cable 120-5 and to a fourth twisted pair on the powered end station 230-2 by the cable 120-4.

FIG. 3B is a schematic diagram depicting an example combiner 310 for a dual power and data system 300 according to a Scheme A embodiment. The combiner 310 comprises a twisted pair 311 connected to a first twisted pair 130-1 in a cable 120-1 and to a first twisted pair 130-5 in a common cable 120-5; a twisted pair 312 connected to a fourth twisted pair 160-1 in the cable 120-1 and to a second twisted pair 140-5 in the common cable 120-5; a twisted pair 313 connected to a first twisted pair 130-2 in a cable 120-2 and to a third twisted pair 150-5 in the common cable 120-5; a twisted pair 314 connected to a fourth twisted pair 160-2 in the cable 120-2 and to a fourth twisted pair 160-5 in the common cable 120-5; and a termination plug 315 attached to a second twisted pair 140-1, a third twisted pair 150-1, a second twisted pair 140-2, and a third twisted pair 150-3. The termination plugs 315 terminate the unused twisted pairs in the cables 120-1 and 120-2.

FIG. 3C is a schematic diagram depicting an example splitter 320 for a dual power and data system 300 according to a Scheme A embodiment. The splitter 320 comprises a twisted pair 321 connected to a first twisted pair 130-5 in a common cable 120-5 and to a first twisted pair 130-3 in a cable 120-3; a twisted pair 322 connected to a second twisted pair 140-5 in the common cable 120-5 and to a fourth twisted pair 160-3 in the cable 120-3; a twisted pair 323 connected to a third twisted pair 140-5 in the common cable 120-5 and to a first twisted pair 130-4 in a cable 120-4; and a twisted pair 324 connected to a fourth twisted pair 160-5 in the common cable 120-5 and to a fourth twisted pair 160-4 in the cable 120-4; and a termination plug 315 attached to a second twisted pair 140-3, a third twisted pair 150-3, a second twisted pair 140-4, and a third twisted pair 150-4. The termination plugs 315 terminate the unused twisted pairs in the cables 120-3 and 120-4.

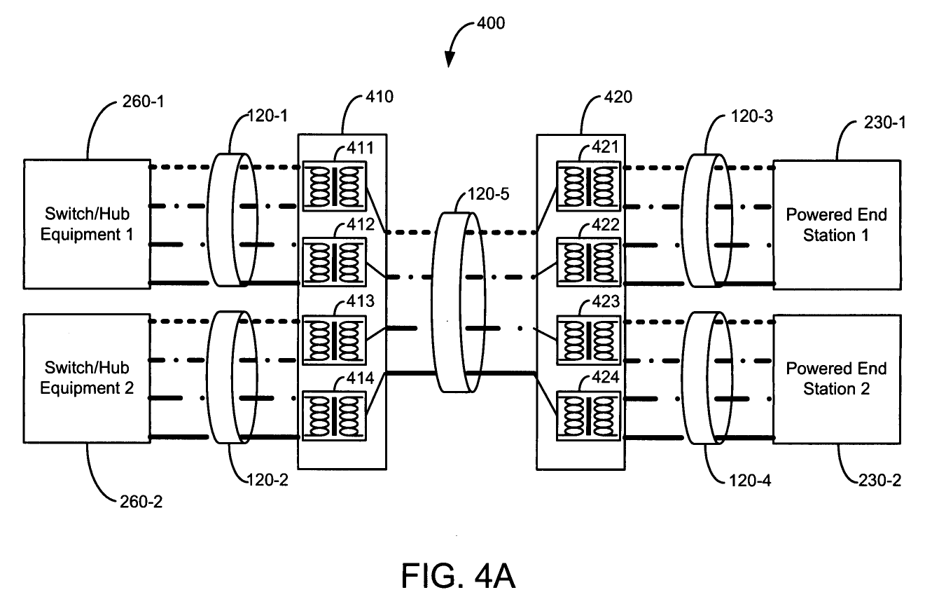

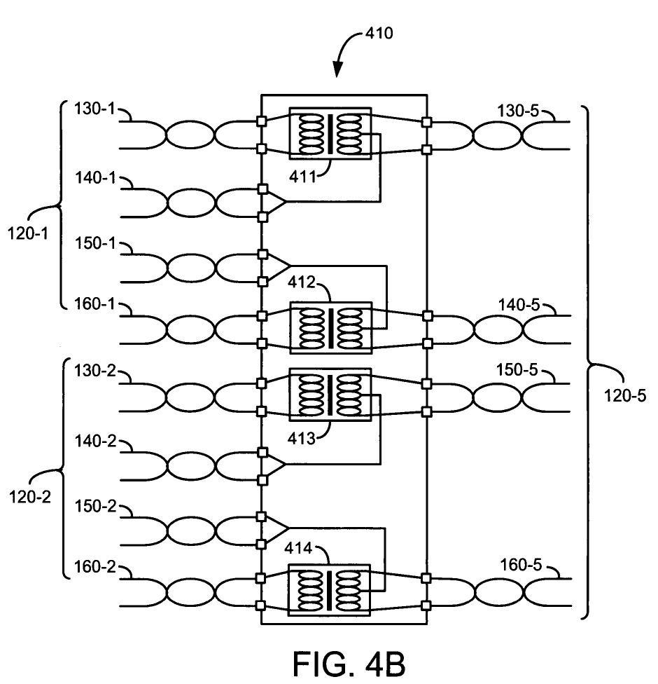

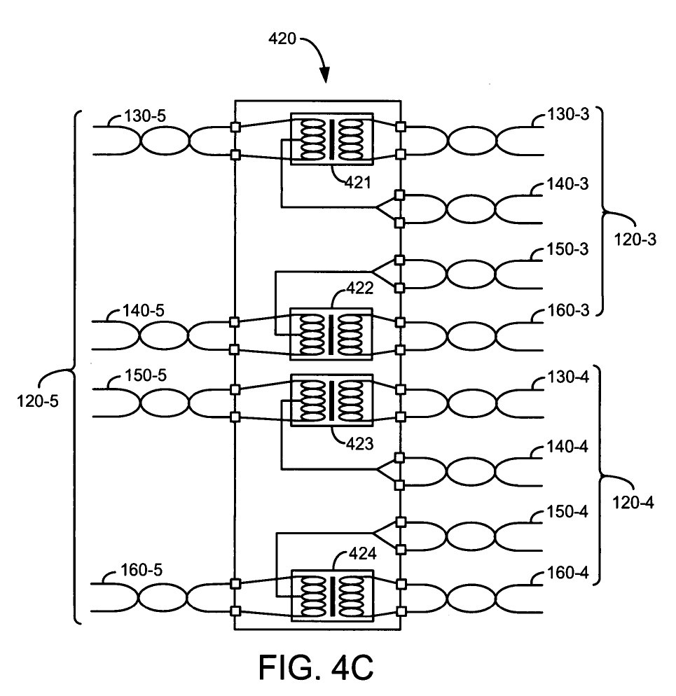

FIGS. 4A-4C are schematic diagrams of an example embodiment of a dual power and data system for remote powering from an endpoint PSE in accordance with Scheme B. The dual power and data system 400 comprises switch/hub equipment 260-1, 260-2; cables 120-1, 120-2, 120-3, 120-4; a common cable 120-5; a combiner 410; a splitter 420; and powered end stations 230-1, 230-2. The cables 120-1, 120-2, 120-3, 120-4 and the common cable 120-5 each comprise four twisted pair connections, such as an Ethernet or Cat 5 cable. The switch/hub equipment 260-1 and 260-2 are configured to provide power and data according to Scheme B for remote powering.

In Scheme B, data and power are provided on separate twisted pair connections in a cable. The dual power and data system 400 utilizes a combiner 410 and a splitter 420 to combine power and data on a single twisted pair and to utilize all four twisted pairs in a cable 120. Accordingly, two powered end stations 230-1 and 230-2 may be powered by one cable. The powered end station 230-1 is operatively connected to the switch/hub equipment 260-1 through the cable 120-3, the splitter 420, the common cable 120-5, the combiner 410, and the cable 120-1. The powered end station 230-2 is operatively connected to the switch/hub equipment 260-2 through the cable 120-4, the splitter 420, the common cable 120-5, the combiner 410, and the cable 120-2.

The combiner 410 is configured to route the signals for cables 120-1 and 120-2 over a common cable 120-5 by utilizing all four twisted pair connections in the common cable 120-5. The combiner 410 comprises four transformers 411, 412, 413 and 414, each configured to couple power and data from separate twisted pairs in cables 120-1, 120-2 onto single twisted pairs in the common cable 120-5.

FIG. 4B depicts a schematic diagram of the combiner 410 configured to couple data and power from separate twisted pair connections in cables 120-1, 120-2 onto a single common cable 120-5. The combiner 410 comprises four transformers 411, 412, 413, 414. The primary of the transformer 411 is connected to a first twisted pair on the switch/hub equipment 260-1 by the cable 120-1. The center tap of the secondary of the transformer 411 is connected to a second twisted pair on the switch/hub equipment 260-1 by the cable 120-1. The secondary of the transformer 411 is connected to a first twisted pair on the common cable 120-5. The primary of the transformer 412 is connected to a fourth twisted pair on the switch/hub equipment 260-1 by the cable 120-1. The center tap of the secondary of the transformer 412 is connected to a third twisted pair on the switch/hub equipment 260-1 by the cable 120-1. The secondary of the transformer 412 is connected to a second twisted pair on the common cable 120-5. The primary of the transformer 413 is connected to a first twisted pair on the switch/hub equipment 260-2 by the cable 120-2. The center tap of the secondary of the transformer 413 is connected to a second twisted pair on the switch/hub equipment 260-2 by the cable 120-2. The secondary of the transformer 413 is connected to a third twisted pair on the common cable 120-5. The primary of the transformer 414 is connected to a fourth twisted pair on the switch/hub equipment 260-2 by the cable 120-2. The center tap of the secondary of the transformer 414 is connected to a third twisted pair on the switch/hub equipment 260-2 by the cable 120-2. The secondary of the transformer 414 is connected to a fourth twisted pair on the common cable 120-5.

The splitter 420 is depicted in FIG. 4C. The splitter 420 is configured to route the signals received from the common cable 120-5 over cables 120-3 and 120-4. The splitter 420 comprises four transformers 421, 422, 423, 424 configured to decouple power and data from twisted pairs in the common cable 120-5 cables onto separate twisted pairs in cables 120-3 and 120-4 connected to the powered end stations 230-1 and 230-2. The primary of the transformer 421 is connected to a first twisted pair on the common cable 120-5. The center tap of the primary of the transformer 421 is connected to a second twisted pair on the powered end station 230-1 by cable 120-3. The secondary of the transformer 421 is connected to a first twisted pair on the powered end station 230-1 by cable 120-3. The primary of the transformer 422 is connected to a second twisted pair on the common cable 120-5. The center tap of the primary of the transformer 422 is connected to a third twisted pair on the powered end station 230-1 by cable 120-3. The secondary of the transformer 422 is connected to a fourth twisted pair on the powered end station 230-1 by cable 120-3. The primary of the transformer 423 is connected to a third twisted pair on the common cable 120-5. The center tap of the primary of the transformer 423 is connected to a second twisted pair on the powered end station 230-2 by cable 120-4. The secondary of the transformer 423 is connected to a first twisted pair on the powered end station 230-2 by cable 120-4. The primary of the transformer 424 is connected to a fourth twisted pair on the common cable 120-5. The center tap of the primary of the transformer 424 is connected to a third twisted pair on the powered end station 230-2 by cable 120-4. The secondary of the transformer 424 is connected to a fourth twisted pair on the powered end station 230-2 by cable 120-4.

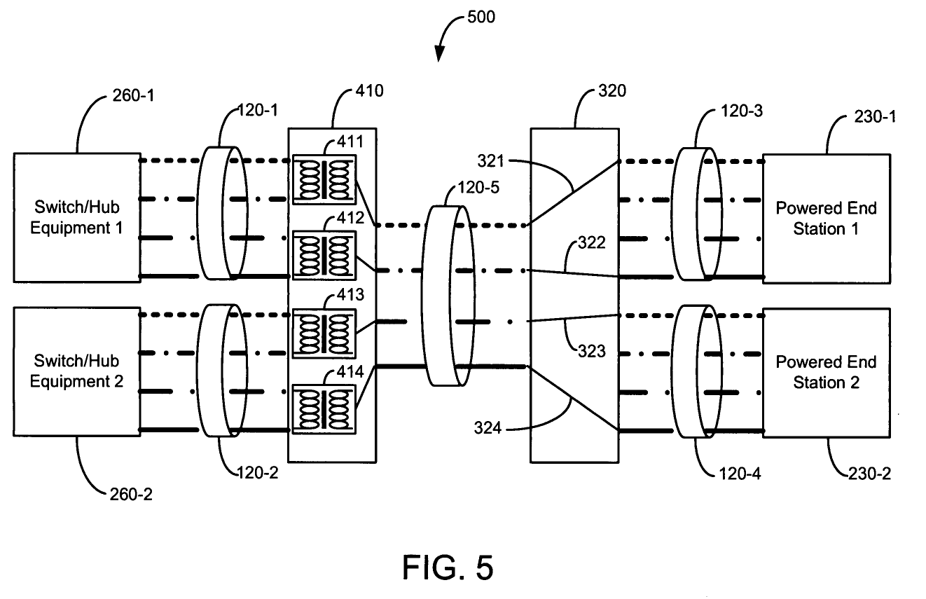

FIG. 5 is a schematic diagram of another example embodiment of a dual power and data system for remote powering from an endpoint PSE. The dual power and data system 500 comprises switch/hub equipment 260-1, 260-2; cables 120-1, 120-2, 120-3, 120-4; a common cable 120-5; a combiner 410; a splitter 320; and powered end stations 230-1, 230-2.

The switch/hub equipment 260-1, 260-2 is configured to provide power and data according to Scheme B for remote powering from an endpoint PSE as depicted in FIG. 2A. In Scheme B, data and power are provided on separate twisted pair connections in a cable. The combiner 410 comprises four transformers 411, 412, 413, 414 configured to couple power and data from separate twisted pairs in cables 120-1, 120-2 onto single twisted pairs in the common cable 120-5 as depicted in FIG. 4B.

The combiner 410 connects to the splitter 320 by the common cable 120-5. The splitter 320 comprises a twisted pair 321 connected to the first twisted pair in the common cable 120-5 and to a first twisted pair on the powered end station 230-1 by the cable 120-3; a twisted pair 322 connected to the second twisted pair in the common cable 120-5 and to a fourth twisted pair on the powered end station 230-1 by the cable 120-3; a twisted pair 323 connected to the third twisted pair in the common cable 120-5 and to a first twisted pair on the powered end station 230-2 by the cable 120-4; and a twisted pair 324 connected to the fourth twisted pair in the common cable 120-5 and to a fourth twisted pair on the powered end station 230-2 by the cable 120-4. The powered end stations 230-1, 230-2 can accept power and data from either Scheme A or Scheme B in accordance with IEEE 802.3af. Thus in this example, the dual power and data system 500 provides power and data from the switch/hub 260-1 and 260-2 according to Scheme B, and the powered end stations 230-1 and 230-2 utilize the power and data according to Scheme A.

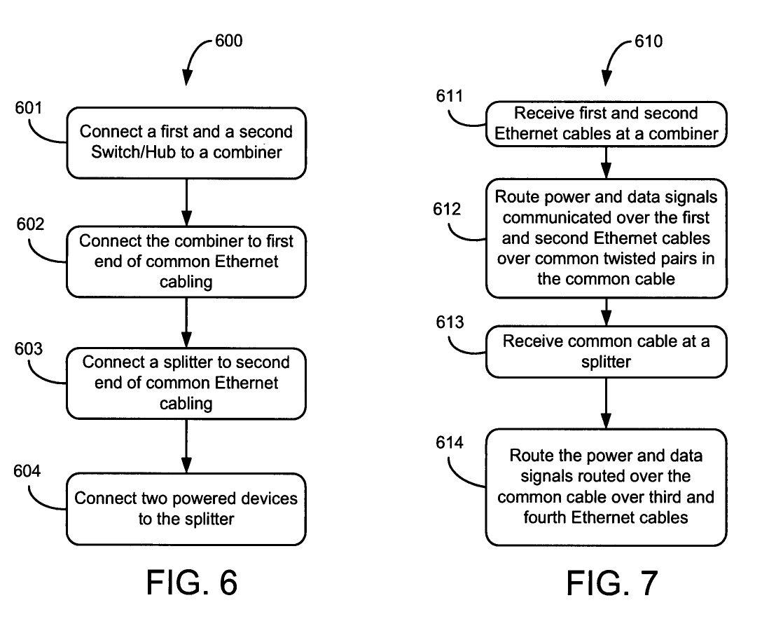

FIG. 6 is a flowchart depicting a method 600 for providing data and power over a common cable to two independent devices. The method 600 comprises connecting a first and a second switch/hub to a combiner, as depicted in step 601. The first and second switch/hub is configured to provide data and power over an Ethernet cable and may be compliant with IEEE 802.3af power over Ethernet standard. The first and second switch/hub may comprise, for example, a server, a router, a switch, a hub, an Internet appliance, or a modem. The connection between the first and second switch/hub and the combiner may comprise at least two Ethernet cables.

The combiner is connected to a first end of a common Ethernet cable, as depicted in Step 602. The combiner is configured to provide the power and data from the first and second switch/hub to a common Ethernet cable. The combiner may comprise, for example, twisted pair wires configured to route two cables to one cable or a plurality of transformers configured to couple data and power to one cable.

A splitter is connected to a second end of the common Ethernet cable, as depicted in Step 603. The splitter is configured to provide the power and data from the common Ethernet cable to two separate powered devices. The splitter may comprise, for example, twisted pair wires configured to rewire the Ethernet cable to route signals from one cable to two cables or a plurality of transformers configured to decouple data and power to two cables.

Two powered devices are connected to the splitter, as depicted in Step 603. The two powered devices may be connected to the splitter by a plurality of Ethernet cables. The Steps 601, 602, 603, 604 may be completed in any order with the method 600 complete when all steps are completed.

FIG. 7 is another flowchart depicting a method 610 for providing data and power over a common cable. Step 611 receives first and second Ethernet cables at a combiner. The first and second Ethernet cables may facilitate PoE according to Scheme A or Scheme B.

Step 612 routes power and data signals communicated over the first and second Ethernet cables over common twisted pairs in the common cable. To carry out step 612, the combiner may be configured to route the power and data signals communicated over the first and second Ethernet cables over common twisted pairs in the common cable as described above.

Step 613 receives the common cable at a splitter, and step 614 communicates the power and data signals routed over the common cable over third and fourth Ethernet cables. To carry out step 614, the splitter may be configured to communicate the power and data signals routed over the common cable over third and fourth Ethernet cables as described above.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A system for providing power and data to at least two Ethernet devices over a common Ethernet cable, comprising:
a combiner circuit configured to receive first and second Ethernet cables and configured to route power and data signals communicated over the first and second Ethernet cables over a common cable; and
a splitter circuit configured to receive the common cable and route the power and data signals routed over the common cable over third and fourth Ethernet cables.

2. The system of claim 1, wherein the combiner circuit is configured to couple power and data signals over common twisted pairs in the common cable.

3. The system of claim 1, wherein the first and second Ethernet cables provide power signals and data signals over common twisted pairs, and wherein the combiner circuit is configured to:
connect two twisted pairs in the first Ethernet cable to corresponding first and second twisted pairs in the common cable; and
connect two twisted pairs in the second Ethernet cable to corresponding third and fourth twisted pairs in the common cable.

4. The system of claim 1, wherein the first and second Ethernet cables provide power signals and data signals over separate twisted pairs, and wherein the combiner circuit comprises:
a first transformer configured to couple a first twisted pair communicating data signals and a second twisted pair communicating power signals in the first Ethernet cable over a first twisted pair in the common cable;
a second transformer configured to couple a third twisted pair communicating data signals and a fourth twisted pair communicating power signals in the first Ethernet cable over a second twisted pair in the common cable;
a third transformer configured to couple a first twisted pair communicating data signals and a second twisted pair communicating power signals in the second Ethernet cable over a third twisted pair in the common cable; and
a fourth transformer configured to couple a third twisted pair communicating data signals and a fourth twisted pair communicating power signals in the first Ethernet cable over a fourth twisted pair in the common cable.

5. The system of claim 4, wherein each transformer defines primary terminals and second terminals, and receives a corresponding twisted pair communicating data signals on primary terminals and receives a corresponding twisted pair communicating power signals at a center tap on secondary terminals.

6. The system of claim 1, wherein the common cable provides power and data signals over common twisted pairs, and wherein the splitter circuit is configured to:
connect first and second twisted pairs in the common cable to two corresponding twisted pairs in the third Ethernet cable; and
connect third and fourth twisted pairs in the common cable to two corresponding twisted pairs in the fourth Ethernet cable.

7. The system of claim 1, wherein the common cable provides power and data signals over common twisted pairs, and wherein the splitter circuit comprises:
a first transformer configured to decouple data signals and power signals communicated over a first twisted pair in the common cable and communicate the data signals over a first twisted pair in the third Ethernet cable and communicate the power signals over a second twisted pair in the third Ethernet cable;
a second transformer configured to decouple data signals and power signals communicated over a second twisted pair in the common cable and communicate the data signals over a third twisted pair in the third Ethernet cable and communicate the power signals over a fourth twisted pair in the third Ethernet cable;
a third transformer configured to decouple data signals and power signals communicated over a third twisted pair in the common cable and communicate the data signals over a first twisted pair in the fourth Ethernet cable and communicate the power signals over a second twisted pair in the fourth Ethernet cable; and
a fourth transformer configured to decouple data signals and power signals communicated over a fourth twisted pair in the common cable and communicate the data signals over a third twisted pair in the fourth Ethernet cable and communicate the power signals over a fourth twisted pair in the fourth Ethernet cable.

8. The system of claim 7, wherein each transformer defines primary terminals and second terminals, and receives a corresponding twisted pair of the common cable communicating data signals and power signals on primary terminals and decouples the power signals by connecting a corresponding twisted pair of the third or fourth Ethernet cables to a center tap defined by the primary terminals.

9. The system of claim 1, further comprising:
first and second power sourcing equipment connected to the first and second Ethernet cables; and
first and second power devices connected to the third and fourth Ethernet cables.

10. A system for providing power and data to at least two Ethernet devices over a common Ethernet cable, comprising:
means for routing power and data signals communicated over first and second Ethernet cables over common twisted pairs in a common cable; and
means for routing the power and data signals routed over the common cable over third and fourth Ethernet cables.

11. A method for providing power and data to at least two Ethernet devices over a common Ethernet cable, comprising:
receiving first and second Ethernet cables communicating power and data signals;
routing the power and data signals communicated over first and second Ethernet cables over common twisted pairs in a common cable;
receiving the common cable at a splitter; and
routing the power and data signals routed over the common cable over third and fourth Ethernet cables.

12. A system configured to provide data and power to two Ethernet devices over a common Ethernet cable, the system comprises:
a first and second power sourcing equipment configured to provide data and power over first and second Ethernet cables;
a combiner connected to the first and second power sourcing equipment by the first and second Ethernet cables;
a splitter connected to the combiner by a common Ethernet cable; and
a first and second powered devices connected to the splitter by a third and fourth Ethernet cable;
wherein the combiner is configured to route the data and power from the first and second switch to the common Ethernet cable; and
wherein the splitter is configured to route the data and power from the common Ethernet cable to the third and fourth Ethernet cable.

13. The system of claim 12 wherein the first and second power sourcing equipment comprise at least one of a switch, a hub, a server, a computer, a router, an Internet appliance, and a modem.

14. The system of claim 12, wherein the first and second powered device comprise at least one of a computer, a wireless sensor, an Internet appliance, a server, and a modem.

15. The system of claim 12, wherein the first and second power sourcing equipment and the first and second powered device operate in accordance with IEEE 802.3af standard.

16. The system of claim 15, wherein the first and second power sourcing equipment is configured to provide data and power on a first and a fourth twisted pair of the first and second Ethernet cables.

17. The system of claim 16, wherein the combiner is configured to:
connect the first and the fourth twisted pair of the first Ethernet cable to a first and a second twisted pair of the common Ethernet cable; and
connect the first and the fourth twisted pair of the second Ethernet cable to a third and a fourth twisted pair of the common Ethernet cable.

18. The system of claim 17, wherein the splitter comprises a plurality of twisted pairs configured to:
connect the first and the second twisted pair of the common Ethernet cable to a first and a fourth twisted pair of the third Ethernet cable; and
connect the third and the fourth twisted pair of the common Ethernet cable to a first and a fourth twisted pair of the fourth Ethernet cable.

19. The system of claim 15, wherein the first and second power sourcing equipment is configured to provide data on a first and a fourth twisted pair of the first and second Ethernet cables and to provide power on a second and a third twisted pair of the first and second Ethernet cables.

20. The system of claim 19, wherein the combiner comprises a first, a second, a third, and a fourth transforming device configured to couple power and data from the first and second Ethernet cables to the common Ethernet cable.

21. The system of claim 20, wherein the first transforming device couples the first twisted pair of the first Ethernet cable and a first twisted pair of the common Ethernet cable, and further comprises center tap secondary coupled to the second twisted pair of the first Ethernet cable.

22. The system of claim 21, wherein the second transforming device couples the fourth twisted pair of the first Ethernet cable and a second twisted pair of the common Ethernet cable, and further comprises center tap secondary coupled to the third twisted pair of the first Ethernet cable.

23. The system of claim 22, wherein the third transforming device couples the first twisted pair of the second Ethernet cable and a third twisted pair of the common Ethernet cable, and further comprises center tap secondary coupled to the second twisted pair of the second Ethernet cable.

24. The system of claim 23, wherein the fourth transforming device couples the fourth twisted pair of the second Ethernet cable and a fourth twisted pair of the common Ethernet cable, and further comprises center tap secondary coupled to the third twisted pair of the second Ethernet cable.

25. The system of claim 12, wherein the splitter comprises a first, a second, a third, and a fourth transforming device configured to decouple power and data from the common Ethernet cable.

26. The system of claim 25, wherein the first transforming device couples a first twisted pair of the common Ethernet cable and a first twisted pair of the third Ethernet cable, and further comprises a center tap primary coupled to a second twisted pair of the third Ethernet cable.

27. The system of claim 26, wherein the second transforming device couples a second twisted pair of the common Ethernet cable and a fourth twisted pair of the third Ethernet cable, and further comprises a center tap primary coupled to a third twisted pair of the third Ethernet cable.

28. The system of claim 27, wherein the third transforming device couples a third twisted pair of the common Ethernet cable and a first twisted pair of the fourth Ethernet cable, and further comprises a center tap primary coupled to a second twisted pair of the fourth Ethernet cable.

29. The system of claim 28, wherein the fourth transforming device couples a fourth twisted pair of the common Ethernet cable and a fourth twisted pair of the fourth Ethernet cable, and further comprises a center tap primary coupled to a third twisted pair of the fourth Ethernet cable.

30. The system of claim 15, wherein the splitter is configured to:
connect a first and a second twisted pair of the common Ethernet cable to a first and a fourth twisted pair of the third Ethernet cable; and
connect a third and a fourth twisted pair of the common Ethernet cable to a first and a fourth twisted pair of the fourth Ethernet cable.
